(19) United States
(12) Patent Application Publication
(10) Pub. No.: US 2023/0119568 A1
(43) Pub. Date: Apr. 20, 2023

(54) PATTERN DETECTION AND PREDICTION USING TIME SERIES DATA

(71) Applicant: INTERNATIONAL BUSINESS MACHINES CORPORATION, Armonk, NY (US)

(72) Inventors: Jin Wang, Xi'an (CN); Lei Gao, Xian (CN); A PENG ZHANG, Xian (CN); Kai Li, Xian (CN); Yan Liu, Xian (CN)

(21) Appl. No.: 17/504,662

(22) Filed: Oct. 19, 2021

(51) Int. Cl. G06F 30/20; G06F 17/16

(52) U.S. Cl. CPC G06F 30/20; G06F 17/16; G06F 2111/10

(57) ABSTRACT

A computer-implemented method includes: obtaining, by a computing device, data from sensors that collect the data in a system during a time, wherein the data is multi-dimensional time series data; creating, by the computing device, matrices based on the data; determining, by the computing device using a first computer-based numerical modeling method, patterns based on the matrices; creating, by the computing device using a second computer-based numerical modeling method, a single time series model based on the patterns; and predicting, by the computing device, a future condition of the system using the time series model with current data of the system.

### BACKGROUND

Aspects of the present invention relate generally to pattern detection and, more particularly, to pattern detection and prediction using time series data.

Time series data such as multi-variate numeric data provided by a set of sensors may be categorized in order to determine particular conditions or states of a system or process. Time series data can be multi-dimensional. For example, multiple sensors can provide data at about the same time, whereby this sensor data can be stacked together to provide a time series that has multiple types of measurements associated with each time point. Multi-dimensional time series data may be collected in an industrial production environment that is equipped with plural sensors that collect data constantly. Multi-dimensional time series data may also be collected in a smart home environment or a computer network environment, to name but a few additional examples.

Time series data may be used to monitor the performance of environments. However, as the number of sensors collecting data is increasing, the manual approach to performance monitoring becomes less feasible. Moreover, the high-level dimensionality of the data being collected by the number of sensors makes it difficult to analyze the data in one period. As a result of the amount of data being collected and the high-level dimensionality of the data, it is becoming more difficult to properly analyze the data and provide insights about systems associated with the data. As such, there exists a technical problem of the inability to adequately analyze massive amounts of time series data obtained from large numbers of sensors detecting different data over a same time.

### SUMMARY

In a first aspect of the invention, there is a computer-implemented method that includes obtaining, by a computing device, data from sensors that collect the data in a system during a time, wherein the data is multi-dimensional time series data. The method includes creating, by the computing device, matrices based on the data. The method includes determining, by the computing device using a first computer-based numerical modeling method, patterns based on the matrices. The method includes creating, by the computing device using a second computer-based numerical modeling method, a single time series model based on the patterns. The method includes predicting, by the computing device, a future condition of the system using the time series model with current data of the system. Embodiments provide an improvement in time series data analysis and prediction by creating the times series model from the determined patterns rather than from raw data.

In an embodiment, each matrix of the matrices is an M×N matrix where M is a number of groups of the sensors and N is a number of dimensions of the data, each value in the M×N matrix is a weighted average of values of plural sensors in a respective one of the groups of sensors, and respective weights of the plural sensors in the respective one of the groups of sensors are based on a distance to a center point of a cluster. In this manner, embodiments advantageously account for different physical locations of the sensors within each group.

In an embodiment, the first computer-based numerical modeling method utilizes an algorithm that includes a first factor based on attenuation of the data over the time. In this manner, embodiments advantageously account for attenuation of the importance of the sensor data to the pattern over time.

In another aspect of the invention, there is a computer program product including one or more computer readable storage media having program instructions collectively stored on the one or more computer readable storage media. The program instructions are executable to obtain data from sensors that collect the data in a system during a time, wherein the data is multi-dimensional time series data. The program instructions are executable to create matrices based on the data. The program instructions are executable to determine patterns based on the matrices using a first computer-based numerical modeling method. The program instructions are executable to create a single time series model based on the patterns using a second computer-based numerical modeling method. The program instructions are executable to predict a future condition of the system using the time series model with current data of the system. Embodiments provide an improvement in time series data analysis and prediction by creating the times series model from the determined patterns rather than from raw data.

In an embodiment, each matrix of the matrices is an M×N matrix where M is a number of groups of the sensors and N is a number of dimensions of the data, each value in the M×N matrix is a weighted average of values of plural sensors in a respective one of the groups of sensors, and respective weights of the plural sensors in the respective one of the groups of sensors are based on a distance to a center point of a cluster. In this manner, embodiments advantageously account for different physical locations of the sensors within each group.

In an embodiment, the first computer-based numerical modeling method utilizes an algorithm that includes a first factor based on attenuation of the data over the time. In this manner, embodiments advantageously account for attenuation of the importance of the sensor data to the pattern over time.

In another aspect of the invention, there is system including a processor, a computer readable memory, one or more computer readable storage media, and program instructions collectively stored on the one or more computer readable storage media. The program instructions are executable to obtain data from sensors that collect the data in a system during a time, wherein the data is multi-dimensional time series data. The program instructions are executable to create matrices based on the data. The program instructions are executable to determine patterns based on the matrices using a first computer-based numerical modeling method. The program instructions are executable to create a single time series model based on the patterns using a second computer-based numerical modeling method. The program instructions are executable to predict a future condition of the system using the time series model with current data of the system. Embodiments provide an improvement in time series data analysis and prediction by creating the times series model from the determined patterns rather than from raw data.

In an embodiment, each matrix of the matrices is an M×N matrix where M is a number of groups of the sensors and N is a number of dimensions of the data, each value in the M×N matrix is a weighted average of values of plural sensors in a respective one of the groups of sensors, and respective weights of the plural sensors in the respective one of the groups of sensors are based on a distance to a center point of a cluster. In this manner, embodiments advantageously account for different physical locations of the sensors within each group.

In an embodiment, the first computer-based numerical modeling method utilizes an algorithm that includes a first factor based on attenuation of the data over the time. In this manner, embodiments advantageously account for attenuation of the importance of the sensor data to the pattern over time.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computer infrastructure according to an embodiment of the present invention.

FIG. 2 shows a block diagram of an exemplary environment in accordance with aspects of the invention.

FIG. 3 shows an exemplary arrangement of groups of sensors in accordance with aspects of the invention.

FIG. 4 shows an example of a matrix of transformed data in accordance with aspects of the invention.

FIG. 5 shows a flowchart of an exemplary method in accordance with aspects of the invention.

### DETAILED DESCRIPTION

Aspects of the present invention relate generally to pattern detection and, more particularly, to pattern detection and prediction using time series data. Implementations of the invention create a time series model based on analyzing multi-dimensional time series data over a number of time windows. In embodiments, a system utilizes weight and attenuation of the sensor data in the multi-dimensional time series data when creating the time series model. In this manner, implementations of the invention may be used to detect patterns in the time series data and, after creating the time series model, to predict future conditions using current sensor data with the detected patterns.

As described herein, a technical problem persists in the inability to adequately analyze massive amounts of time series data obtained from large numbers of sensors detecting different data over a same time. Aspects of the invention address this technical problem by providing a technical solution that includes: obtaining data from sensors that collect the data in a system during a time, wherein the data is multi-dimensional time series data; creating matrices based on the data; determining, using a first computer-based numerical modeling method, patterns based on the matrices; creating, using a second computer-based numerical modeling method, a single time series model based on the patterns; and predicting a future condition of the system using the time series model with current data of the system. In one exemplary embodiment, the system is an industrial manufacturing environment, and the data is from hundreds or even thousands of temperature sensors and humidity sensors in the environment. In this example, a quality of production is a condition of the system that is quantified over the same time that the sensors collect the data. In this example, embodiments of the invention may be used to determine patterns of a relationship between the sensor data and the quality of production and create a time series model based on these patterns. The time series model can be used with current data from the sensors to predict a future condition (e.g., a future quantified state of the quality of production). In this manner, when the time series model predicts a future condition that is undesirable (e.g., the quality of production drops below a threshold value), the operator of the environment may adjust one or more system controls (e.g., adjust a cooling system to lower a temperature of the system) to avoid the predicted undesirable future condition. Accordingly, in this example, an embodiment of the invention provides a technical solution to the technical problem of analyzing time series data collected in the industrial manufacturing environment and using the analysis to improve manufacturing processes in the environment. Implementations of the invention are not limited to use with industrial manufacturing, and embodiments may be used with time series data from other environments including but not limited to smart home environments and computer network environments.

Implementations of the invention provide an improvement to the technology of performance monitoring. In particular, embodiments utilize techniques that obtain sensor data, transform that sensor data into aggregated sensor data, generate a new time series model using the aggregated sensor data, and then use the new time series model to predict a future operating condition of a system. In this manner, embodiments utilize two steps of generating new data: the first step being generating the aggregated sensor data, and the second step being generating the time series model. In this manner, implementations of the invention provide an improvement in methods of monitoring the performance of a system and predicting future conditions of the system.

In an exemplary embodiment, a method includes: recording a number N dimensions of data with a number M groups of sensors and forming an M×N matrix for each cycle that the data is collected; using one L width window to slide the records; and building one time series model for beta vectors for future prediction of a condition related to the data. Aspects of this embodiment include: forming the M×N matrix to reduce high-level dimension period data for each user defined cycle, based on weights applied to the data; defining one method based on the pattern to predict the trend; and using a machine learning model and a data transformation method based on the pattern to predict the trend.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

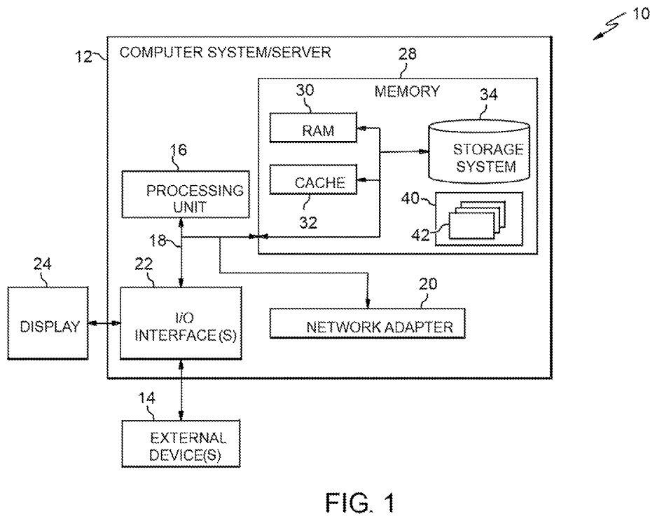

Referring now to FIG. 1, a schematic of an example of a computer infrastructure is shown. Computer infrastructure 10 is only one example of a suitable computer infrastructure and is not intended to suggest any limitation as to the scope of use or functionality of embodiments of the invention described herein. Regardless, computer infrastructure 10 is capable of being implemented and/or performing any of the functionality set forth hereinabove.

In computer infrastructure 10 there is a computer system 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system executable instructions, such as program modules, being executed by a computer system. Generally, program modules may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system 12 in computer infrastructure 10 is shown in the form of a general-purpose computing device. The components of computer system 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18. It should be understood that although not shown, other hardware and/or software components could be used in conjunction with computer system 12. Examples, include, but are not limited to: microcode, device drivers, redundant processing units, external disk drive arrays, RAID systems, tape drives, and data archival storage systems, etc.

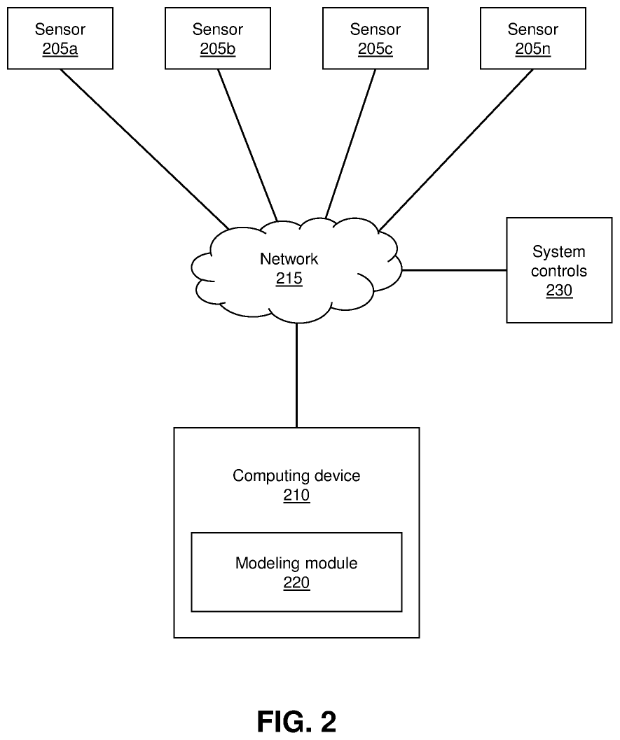

FIG. 2 shows a block diagram of an exemplary environment in accordance with aspects of the invention. In embodiments, the environment includes plural sensors 205a, 205b, 205c, . . . , 205n, where n represents the total number of sensors. The number of sensors can be in the tens, hundreds, or thousands. In embodiments, the sensors 205a-n collect time series data in an environment, such as a manufacturing environment, computer network environment, or a smart home environment. Aspects of the invention are described for illustrative purposes using the example of a manufacturing environment; however, implementations of the invention are not limited to use with a manufacturing environment.

According to aspects of the invention, the sensors 205a-n collect at least two different types of data. By collecting different types of data at different points in time during a same time period, the sensors 205a-n provide multi-dimensional time series data. In the illustrative example of the example of a manufacturing environment, the sensors 205a-n collect temperature data and humidity data at different locations in the manufacturing environment at different points in time during a same time period. In one example, the sensors 205a-n comprise two different types of sensors, e.g., a first subset of the sensors 205a-n that collect temperature data and a second subset of the sensors 205a-n that collect humidity data. As used herein, the number of different types of data defines the number of dimensions N of the data. Thus, for the example of the manufacturing environment with sensors that collect temperature data and sensors that collect humidity data, the number of dimensions N=2. Implementations of the invention are not limited to N=2, and other numbers of N may be used.

With continued reference to FIG. 2, the environment includes a computing device 210 that obtains data from the sensors 205a-n via a network 215. The network 215 includes one or more communication networks such as one or more of a LAN, WAN, and the Internet.

The computing device 210 includes one or more elements of the computer system 12 of FIG. 1, and may be a desktop computer, laptop computer, workstation computer, etc. In embodiments, the computing device 210 comprises a modeling module 220, which may comprise one or more program modules such as program modules 42 described with respect to FIG. 1. The modeling module 220 is configured to perform one or more steps of methods according to aspects of the invention, including: obtaining data from sensors the 205a-n; creating matrices based on the data; determining using a first computer-based numerical modeling method, patterns based on the matrices; creating, using a second computer-based numerical modeling method, a single time series model based on the patterns; and predicting a future condition of the system using the time series model with current data from sensors the 205a-n.

The computing device 210 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

Still referring to FIG. 2, in embodiments the environment includes one or more system controls 230. The system controls 230 are controls that affect the operation of the system in which the sensors 205a-n are arranged. In the example of the manufacturing environment where the sensors 205a-n collect temperature and humidity data, the system controls 230 may be used to control a heating, ventilation, and air conditioning (HVAC) system that controls the temperature and humidity in the manufacturing environment. In embodiments, the system controls 230 are controlled by computer such as the computing device 210 and/or another computer in the system.

According to aspects of the invention, the sensors 205a-n collect data over a number of cycles (e.g., minutes, hours, days, months, etc.), and the modeling module 220 creates an M×N matrix of transformed data for each cycle, where M is a number of groups of the sensors 205a-n and N is a number of dimensions of data collected by the sensors 205a-n.

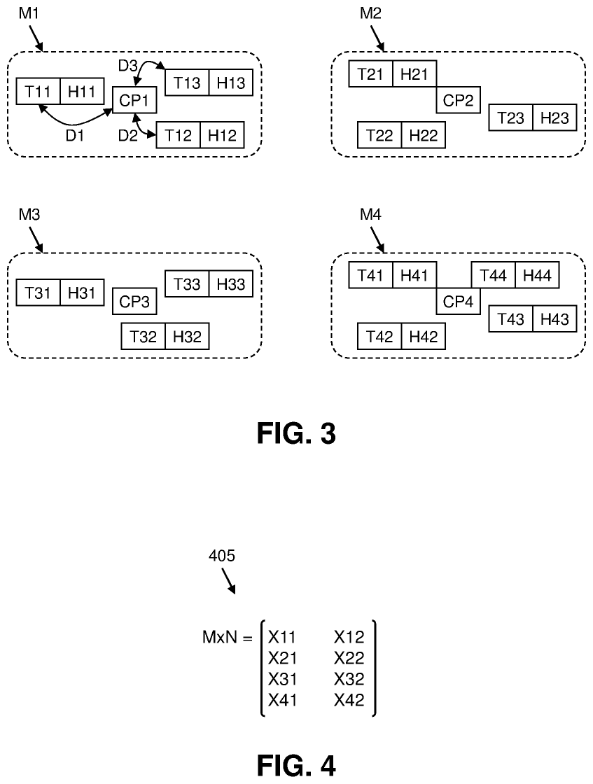

FIG. 3 shows an exemplary arrangement of groups of sensors in accordance with aspects of the invention. In the example shown in FIG. 3, there are four groups M1, M2, M3, M4. In each group there are temperature sensors indicated by Tmj and humidity sensors indicated by Hmj, where “m” denotes the group number and “j” denotes the number of this type of sensor in this group. In this example, group M1 has sensors T11, T12, T13, H11, H12, and H13, where T11 is the first temperature sensor in this group, T12 is the second temperature sensor in this group, T13 is the third temperature sensor in this group, H11 is the first humidity sensor in this group, H12 is the second humidity sensor in this group, and H13 is the third humidity sensor in this group. Similarly, group M2 has three temperature sensors T21, T22, T23 and three humidity sensors H21, H22, H23. Similarly, group M3 has three temperature sensors T31, T32, T33 and three humidity sensors H31, H32, H33. Similarly, group M4 has four temperature sensors T41, T42, T43, T44 and four humidity sensors H41, H42, H43, H44. Each of the sensors shown in FIG. 3 is representative of one of the sensors 205a-n of FIG. 2. In this example, the sensors collect two types of data (e.g., temperature and humidity) so the number of dimensions of data N=2, and there are four groups so M=4. In embodiments, and as described at FIG. 4, the modeling module 220 obtains data from all the sensors in groups M1-M4 and creates an M×N matrix of transformed data for each cycle that the data is obtained.

Still referring to FIG. 3, in embodiments the groups M1-M4 are defined using a clustering method, with each sensor belonging to only one group. For example, user-defined center points CP1, CP2, CP3, CP4 may be defined, and a clustering method may be used to define clusters of the sensors based on distances to the center points. For example, all the sensors in group M1 are closer to the center point CP1 than they are to any other center point CP2, CP3, CP4. Similarly, all the sensors in group M2 are closer to the center point CP2 than they are to any other center point CP1, CP3, CP4. Similarly, all the sensors in group M3 are closer to the center point CP3 than they are to any other center point CP1, CP2, CP4. Similarly, all the sensors in group M4 are closer to the center point CP4 than they are to any other center point CP1, CP2, CP3. By defining location coordinates of all the sensors and the location coordinates of all the center points, the modeling module 220 may use a clustering algorithm to define the groups of sensors in this manner according to their relative distances to the center points, with each sensor being placed in a group with a center point to which the senor is physically closest. The center points CP1, CP2, CP3, CP4 may be defined as corresponding to certain devices in the environment, such as air conditioners, for example.

FIG. 4 shows an example of an M×N matrix 405 of transformed data in accordance with aspects of the invention. In embodiments, the matrix 405 includes plural values Xmn where “m” denotes the group number and “n” denotes the data dimension. Using the exemplary sensor arrangement from FIG. 3, the value X11 in the matrix 405 is a transformed data value that represents the first data dimension (e.g., temperature) of the first group (e.g., M1) for this cycle. Similarly, the value X21 in the matrix 405 is a transformed data value that represents the first data dimension (e.g., temperature) of the second group (e.g., M2) for this cycle. Similarly, the value X31 in the matrix 405 is a transformed data value that represents the first data dimension (e.g., temperature) of the third group (e.g., M3) for this cycle. Similarly, the value X41 in the matrix 405 is a transformed data value that represents the first data dimension (e.g., temperature) of the fourth group (e.g., M4) for this cycle. Similarly, the value X12 in the matrix 405 is a transformed data value that represents the second data dimension (e.g., humidity) of the first group (e.g., M1) for this cycle. Similarly, the value X22 in the matrix 405 is a transformed data value that represents the second data dimension (e.g., humidity) of the second group (e.g., M2) for this cycle. Similarly, the value X32 in the matrix 405 is a transformed data value that represents the second data dimension (e.g., humidity) of the third group (e.g., M3) for this cycle. Similarly, the value X42 in the matrix 405 is a transformed data value that represents the second data dimension (e.g., humidity) of the fourth group (e.g., M4) for this cycle.

With continued reference to FIGS. 3 and 4, in embodiments each value Xmn in the matrix 405 is a weighted average of the plural values of the plural sensors for that particular data dimension in that particular group. For example, the value X11 is a weighted average of the values of sensors T11, T12, T13 for this cycle. Similarly, the value X21 is a weighted average of the values of sensors T21, T22, T23 for this cycle. Similarly, the value X31 is a weighted average of the values of sensors T31, T32, T33 for this cycle. Similarly, the value X41 is a weighted average of the values of sensors T41, T42, T43, T44 for this cycle. Similarly, the value X12 is a weighted average of the values of sensors H11, H12, H13 for this cycle. Similarly, the value X22 is a weighted average of the values of sensors H21, H22, H23 for this cycle. Similarly, the value X32 is a weighted average of the values of sensors H31, H32, H33 for this cycle. Similarly, the value X42 is a weighted average of the values of sensors H41, H42, H43, H44 for this cycle.

With continued reference to FIGS. 3 and 4, in embodiments the modeling module 220 determines the weighted averages using respective weights assigned to each sensor in a group. In one example, the weight for each sensor in a group is user-defined. In another example, the modeling module 220 determines the weight for each sensor in a group based on the location of that sensor relative to the center point of that group. Using group M1 for example, the weight of sensor T11 is based on the distance D1 between sensor T11 and CP1 Similarly, the weight or sensor T12 is based on the distance D2 between sensor T12 and CP1, and the weight or sensor T13 is based on the distance D3 between sensor T13 and CP1.

In embodiments, the modeling module 220 determines the weight Wj of the j^{th} sensor in a group using Equation 1, which is given as:

$$Wj = \frac{D max adjusted - Dj}{{Σ}_{j = 0}^{s} ( D max adjusted - Dj )} \qquad ( 1 )$$

In Equation 1, Wj is the weight of the j^{th} sensor in the group, Dmaxadjusted is an adjusted value of a largest distance of any sensor in the group to the center point of the group, Dj is the distance of the j^{th} sensor to the center point of the group, and s is the number of sensors in the group. In embodiments, the modeling module 220 determines Dmaxadjusted for a group by adding a predefined small value to the largest distance of a sensor in the group to the center point of the group. Taking group M1 of FIG. 3 for example, assuming that D1>D2>D3, then D1 is the largest distance, and Dmaxadjusted is D1 plus a predefined small value (e.g., 0.001). After determining Dmaxadjusted for a group, the modeling module 220 determines a weight for each sensor in the group according to Equation 1, and then calculates the adjusted value Xmn (of the M×N matrix 405) by using these weights to determine a weighted average of the data values of the sensors in this group.

With continued reference to FIGS. 3 and 4, in embodiments the modeling module 220 calculates all the values Xmn in the M×N matrix 405 using the method described above, e.g., for each value in the matrix calculating a weighted average of the plural values of the plural sensors for that particular data dimension in that particular group. In this manner, by calculating each single value Xmn from the values of plural sensors in a group, the system transforms the time series data to reduce the complexity of the data. Moreover, by calculating each single value Xmn using a weighted average of the values of the plural sensor where the weights are based on distances of the sensors from a center point, the system transforms the time series data to account for different physical locations of the sensors within each group.

In embodiments, the modeling module 220 calculates a respective M×N matrix 405 for each of plural different cycles of the time series data collected by the sensors, where each individual cycle corresponds to a respective record. For example, the modeling module 220 may be configured to define L number of records from the sensor data by sliding a fixed-width window along the time series data sensor data. Using these defined records the of sensor data, the module creates L number of M×N matrices 405, one matrix for each record.

According to aspects of the invention, after creating the L number of M×N matrices for the L number of records of data from the sensors, the modeling module 220 determines patterns based on the matrices. In embodiments, the modeling module 220 determines a respective pattern based on each respective M×N matrix. In embodiments, the pattern determined by the modeling module 220 for a particular M×N matrix is a vector of coefficients B that satisfy Equation 2 for values included in the particular M×N matrix and for a target value y.

y=Σₖ₌₀^{M}Bₖwₖxₖ (2)

In Equation 2, the target value “y” is a quantifiable value associated with the system in which the sensors are arranged. In embodiments, the target value y changes over time and, thus, is also time series data. In one example, the target value y is a quantifiable measure of the quality of a product being manufactured in the manufacturing environment, where the quality is affected by the temperature and humidity of the manufacturing environment. In one particular example, the manufacturing environment makes plastic items, and the target y is a quantifiable value of a brittleness of the plastic that is measured and cataloged over the same time period that the sensors collect data. In an example of a computer network environments, the target value y is a measured time to load a website, and the sensor data is CPU and I/O counts of computing devices used in the network. In an example of a smart home environment, the target value y is a measured latency of data transmission between devices in a smart home local network, and the sensor data is network signal strength and voltage of devices used in the smart home local network. These examples are not limiting, and implementations of the invention may be used with other systems that collect times series data of measured parameters and time series data of a target value that is affected by the measured parameters.

Still referring to Equation 2, the value “x” is a value Xmn from the M×N matrix for this record. The value “w” is an attenuation factor that is defined by Equation 3 as:

wₖ=e^{-c*(L-k)} (3)

In embodiments, the attenuation factor w is used to account for reduced impact of data over time from one record to the next record (e.g., from one cycle to the next cycle). In Equation 3, the value “c” is an experience factor that is used to modify the attenuation speed. The value of c is used defined based on expertise and may be initially set to a value of 1. In Equation 3, the value L is the number of records as already described, for which there is one M×N matrix for each record.

Using the example shown in FIGS. 3 and 4, an exemplary expansion of Equation 2 is shown as Equation 5.

y=B1*w1*[X11,X12]^{T}+B2*w2*[X21,X22]^{T}+B3*w3*[X31,X32]^{T}+B4*w4*[X41,X42]^{T} (5)

In this example, the modeling module 220 uses a first computer-based numerical modeling method to solve for a vector Beta[B1,B2,B3,B4] (referred to herein as a Beta vector) that satisfies Equation 5 using the target value y and the values Xmn of the M×N matrix for this particular record. In a particular embodiment, each component of the Beta vector is an N-dimensional vector, such that B1=[beta11,beta12], etc. The modeling module 220 may be programmed to use a least square method to solve for the Beta vector, although embodiments are not limited to a least square method.

In embodiments, the modeling module 220 determines a respective Beta vector for each record in the L number of records in the manner described herein, e.g., using Equation 2 and the respective target value y and the values Xmn of the respective M×N matrix for the particular record at issue. In this manner, the modeling module 220 determines a number of Beta vectors corresponding to the L number of records, respectively. As described herein, each respective Beta vector represents a pattern of the target value and sensor data for a respective record of the time series data. In this manner, the modeling module 220 determines patterns based on the plural M×N matrices.

According to aspects of the invention, after determining the plural patterns (e.g., the Beta vectors), the modeling module 220 creates a single time series model based on the patterns. In embodiments, the modeling module 220 is programmed to use a second computer-based numerical modeling method to form a linear regression for the patterns and sensor data. For example, the plural Beta vectors determined using the window slide are relative to each other based on time and, thus, the group of plural Beta vectors constitutes time series data. In embodiments, the modeling module 220 uses a time series numerical modeling method, such as an autoregressive-moving-average (ARMA) model, for example, to build a single time series model that predicts a future Beta vector for a cycle that has not yet occurred. For example, after determining plural Beta vectors B1, B2, B3, . . . , BN in the manner described herein, the modeling module 220 then uses those plural Beta vectors with an ARMA model to create a time series model that predicts a future Beta vector B(N+1). Embodiments are not limited to using an ARMA model in this step.

According to aspects of the invention, after creating the single time series model, the modeling module 220 predicts a future condition of the system using the time series model with current data of the system. In embodiments, the modeling module 220 uses the time series model to predict a Beta vector for a future cycle that has not yet happened, e.g., at time t(N+1). The modeling module 220 then uses the data contained in the M×N matrix for the current time period, e.g., at time t(N), with the predicted Beta vector to determine the target value y at time t(N+1). For example, the modeling module 220 may solve Equation 2 for y using the M×N matrix for time t(N) and the precited Beta vector for time t(N+1). In this manner, the modeling module 220 predicts the target value y for time t(N+1), which represents a future condition of the system. In contrast to a time series analysis that builds a model directly on the sequence data, embodiments split the sequence data into to several parts using a slide window (which may include overlapping parts decided by the width of the window and step). In this manner, embodiments focus on the patterns rather than the exact numbers, and this provides a more holistic view of the relationship.

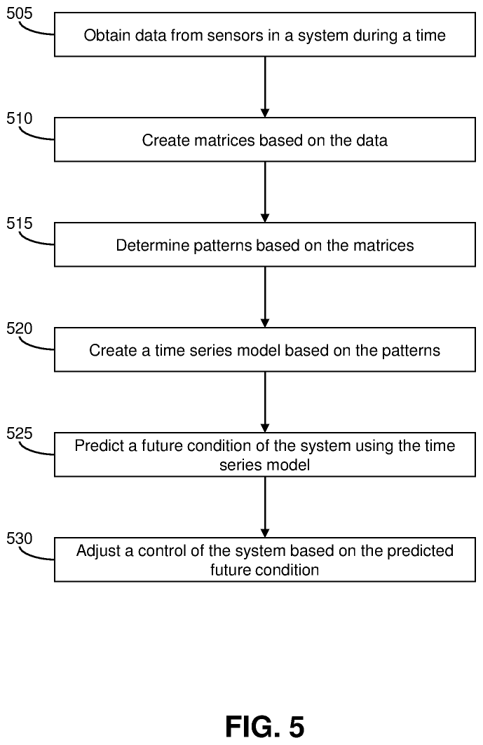

FIG. 5 shows a flowchart of an exemplary method in accordance with aspects of the present invention. Steps of the method may be carried out in the environment of FIG. 2 and are described with reference to elements depicted in FIGS. 2-4.

At step 505, the computing device 210 obtains data from the sensors 205a-n at different points in time during a same time period. In embodiments, and as described with respect to FIG. 2, the data obtained from the sensors 205a-n is multi-dimensional time series data. In embodiments, and as described with respect to FIG. 2, the modeling module 220 obtains the data from the sensors 205a-n via a network 215.

At step 510, the computing device 210 creates matrices based on the data that was obtained at step 505. In embodiments, and as described with respect to FIGS. 2-4, the modeling module 220 creates L number of M×N matrices by applying transformations to the sensor data that was obtained at step 505.

At step 515, the computing device 210 determines patterns based on the matrices that were created at step 510. In embodiments, and as described with respect to FIGS. 2-4, the modeling module 220 determines plural Beta vectors using the M×N matrices, e.g., by solving Equation 2 using a first computer-based numerical modeling method such as a least square method.

At step 520, the computing device 210 creates a time series model based on the patterns determined at step 515. In embodiments, and as described with respect to FIGS. 2-4, the modeling module 220 creates a time series model using the plural Beta vectors, e.g., using a second computer-based numerical modeling method such as an ARMA model, for example.

At step 525, the computing device 210 predicts a future condition of the system using the time series model that was created at step 520. In embodiments, and as described with respect to FIGS. 2-4, the modeling module 220 predicts a future Beta vector for a future cycle of the system using the time series model, and then uses the future Beta vector to predict a future target value y of the system e.g., using Equation 2.

At step 530, the computing device 210 adjusts a system control 230 based on the future condition of the system that was predicted at step 525. In embodiments, when the time series model predicts a future condition that is undesirable (e.g., the quality of production drops below a threshold value), the operator of the environment may adjust one or more system controls (e.g., adjust a cooling system to lower a temperature of the system) to avoid the predicted undesirable future condition.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
obtaining, by a computing device, data from sensors that collect the data in a system during a time, wherein the data is multi-dimensional time series data;
creating, by the computing device, matrices based on the data;
determining, by the computing device using a first computer-based numerical modeling method, patterns based on the matrices;
creating, by the computing device using a second computer-based numerical modeling method, a single time series model based on the patterns; and
predicting, by the computing device, a future condition of the system using the time series model with current data of the system.

2. The method of claim 1, wherein each matrix of the matrices is an M×N matrix where M is a number of groups of the sensors and N is a number of dimensions of the data.

3. The method of claim 2, wherein each value in the M×N matrix is a weighted average of values of plural sensors in a respective one of the groups of sensors.

4. The method of claim 3, wherein respective weights of the plural sensors in the respective one of the groups of sensors are based on a distance to a center point of a cluster.

5. The method of claim 1, wherein the determining the patterns comprises:
defining a number of windows each representing a respective period of the time; and
determining a respective vector of coefficients for each one of the windows, wherein the vector of coefficients for a particular one of the windows represents a pattern between a condition of the system measured during the respective period of the time and the data collected during the respective period of the time.

6. The method of claim 1, wherein the first computer-based numerical modeling method utilizes an algorithm that includes a first factor based on attenuation of the data over the time.

7. The method of claim 6, wherein the algorithm includes a second factor that defines a speed of the attenuation.

8. The method of claim 1, wherein the first computer-based numerical modeling method is different than the second computer-based numerical modeling method.

9. The method of claim 1, further comprising adjusting a control of the system based on the predicted future condition.

10. The method of claim 1, wherein the predicting comprises:
predicting a future pattern using the single time series model; and
predicting a future target value of the system using the future pattern.

11. A computer program product comprising one or more computer readable storage media having program instructions collectively stored on the one or more computer readable storage media, the program instructions executable to:
obtain data from sensors that collect the data in a system during a time, wherein the data is multi-dimensional time series data;
create matrices based on the data;
determine patterns based on the matrices using a first computer-based numerical modeling method;
create a single time series model based on the patterns using a second computer-based numerical modeling method; and
predict a future condition of the system using the time series model with current data of the system.

12. The computer program product of claim 11, wherein:
each matrix of the matrices is an M×N matrix where M is a number of groups of the sensors and N is a number of dimensions of the data;
each value in the M×N matrix is a weighted average of values of plural sensors in a respective one of the groups of sensors; and
respective weights of the plural sensors in the respective one of the groups of sensors are based on a distance to a center point of a cluster.

13. The computer program product of claim 11, wherein the determining the patterns comprises:
defining a number of windows each representing a respective period of the time; and
determining a respective vector of coefficients for each one of the windows, wherein the vector of coefficients for a particular one of the windows represents a pattern between a condition of the system measured during the respective period of the time and the data collected during the respective period of the time.

14. The computer program product of claim 11, wherein:
the first computer-based numerical modeling method utilizes an algorithm that includes a first factor based on attenuation of the data over the time; and
the algorithm includes a second factor that defines a speed of the attenuation.

15. The computer program product of claim 11, wherein the program instructions are executable to adjust a control of the system based on the predicted future condition.

16. A system comprising:
a processor, a computer readable memory, one or more computer readable storage media, and program instructions collectively stored on the one or more computer readable storage media, the program instructions executable to:
obtain data from sensors that collect the data in a system during a time, wherein the data is multi-dimensional time series data;
create matrices based on the data;
determine patterns based on the matrices using a first computer-based numerical modeling method;
create a single time series model based on the patterns using a second computer-based numerical modeling method; and
predict a future condition of the system using the time series model with current data of the system.

17. The system of claim 16, wherein:
each matrix of the matrices is an M×N matrix where M is a number of groups of the sensors and N is a number of dimensions of the data;
each value in the M×N matrix is a weighted average of values of plural sensors in a respective one of the groups of sensors; and
respective weights of the plural sensors in the respective one of the groups of sensors are based on a distance to a center point of a cluster.

18. The system of claim 16, wherein the determining the patterns comprises:
defining a number of windows each representing a respective period of the time; and
determining a respective vector of coefficients for each one of the windows, wherein the vector of coefficients for a particular one of the windows represents a pattern between a condition of the system measured during the respective period of the time and the data collected during the respective period of the time.

19. The system of claim 16, wherein:
the first computer-based numerical modeling method utilizes an algorithm that includes a first factor based on attenuation of the data over the time; and
the algorithm includes a second factor that defines a speed of the attenuation.

20. The system of claim 16, wherein the program instructions are executable to adjust a control of the system based on the predicted future condition.
